(19) United States
(12) Patent Application Publication
(10) Pub. No.: US 2024/0241513 A1
(43) Pub. Date: Jul. 18, 2024

(54) METHOD AND APPARATUS FOR UPDATING PREDICTIVE MODEL PREDICTING PRODUCT FAILURE

(71) Applicant: SAMSUNG ELECTRONICS CO., LTD., Suwon-si (KR)

(72) Inventors: Chonghoon LEE, Suwon-si (KR); Yeonkyu PARK, Suwon-si (KR); Jinyong PARK, Suwon-si (KR)

(21) Appl. No.: 18/421,475

(22) Filed: Jan. 24, 2024

Related U.S. Application Data
(63) Continuation of application No. PCT/KR2022/008209, filed on Jun. 10, 2022.

(30) Foreign Application Priority Data
Jul. 30, 2021 (KR) 10-2021-0100878

(51) Int. Cl. G05B 23/02

(52) U.S. Cl. CPC G05B 23/0297; G05B 23/0283

(57) ABSTRACT

Various embodiments of the present disclosure disclose a method and apparatus, and comprise: a communication module comprising communication circuitry; a memory; and at least one processor comprising processing circuitry operatively connected to the communication module and/or the memory, wherein at least one processor is configured to: generate an AI predictive model based on component input data; acquire fail result data according to the AI predictive model;

acquire pass result data according to the fail result data; and update the AI predictive model based on at least one of the component input data, the fail result data, and the pass result data.

### CROSS-REFERENCE TO RELATED APPLICATIONS

This application is a continuation of International Application No. PCT/KR2022/008209 designating the United States, filed on Jun. 10, 2022, in the Korean Intellectual Property Receiving Office and claiming priority to Korean Patent Application No. 10-2021-0100878, filed on Jul. 30, 2021, in the Korean Intellectual Property Office, the disclosures of each of which are incorporated by reference herein in their entireties.

### BACKGROUND

### Field

The disclosure relates to a method and an apparatus for updating a predictive model for predicting a product failure.

### Description of Related Art

With the advancement of digital technology, various types of electronic devices, such as a mobile communication terminal, a personal digital assistant (PDA), an electronic organizer, a smartphone, a tablet personal computer (PC), or a wearable device, are widely used. In order to support and improve the functions of electronic devices, hardware and/or software of electronic devices is continuously being developed.

Electronic devices may include a plurality of components (or electronic components) (e.g., a processor, a camera, and an antenna) to provide various functions. Once an electronic device is manufactured, the electronic device may be tested to identify whether there is an abnormality. Since it is impossible to test every electronic device produced, a subset of electronic devices may be tested out of all produced electronic devices. Conventionally, electronic devices are tested using predictive models.

A conventional performance test of a complete product (e.g., an electronic devices) may be performed using data about a component (or an electronic component) (e.g., a processor and a camera). Conventionally, since performance (e.g., pass/fail) of a complete product is predicted using only a result of testing a component instead of testing performance of the complete product, the same prediction result may always be provided. Further, a result of testing a complete product may vary due to changing external factors even though the same component is used. Since a conventional predictive model is not updated once produced, accuracy of the predictive model predicting good or defective products may decrease over time.

### SUMMARY

Embodiments of the disclosure may provide a method and an apparatus for generating an artificial intelligence (AI) predictive model, based on component input data, obtaining fail result data according to the AI predictive model, obtaining pass result data according to the fail result data, and updating the AI predictive model, based on at least one of the component input data, the fail result data, or the pass result data.

An electronic device according to various example embodiments of the disclosure may include: a communication module comprising communication circuitry, a memory, and at least one processor comprising processing circuitry operatively connected to the communication module and/or the memory, wherein at least one processor may be configured to: generate an artificial intelligence (AI) predictive model, based on component input data, obtain fail result data according to the AI predictive model, obtain pass result data according to the fail result data, and update the AI predictive model, based on at least one of the component input data, the fail result data, and the pass result data.

An AI prediction system according to various example embodiments of the disclosure may include: an electronic device, comprising circuitry, configured to obtain fail result data according to an AI predictive model, obtain pass result data according to the fail result data, and transmit at least one of component input data, the fail result data, or the pass result data to a server, wherein the server is configured to generate and/or update the AI predictive model, based on at least one of the component input data, the fail result data, or the pass result data, and transmit the AI predictive model to the electronic device.

An operating method of an electronic device according to various example embodiments of the disclosure may include: generating an artificial intelligence (AI) predictive model, based on component input data, obtaining fail result data according to the AI predictive model, obtaining pass result data according to the fail result data, and updating the AI predictive model, based on at least one of the component input data, the fail result data, and the pass result data.

According to various example embodiments, an AI predictive model of a complete product (e.g., an electronic device) may be updated based on at least one of component input data, fail result data, or pass result data, thereby maintaining accuracy of the AI predictive model predicting normal and failure.

According to various example embodiments, when data is predicted as being normal but is determined as a failure as a result of testing a complete product, an AI predictive model may be trained using the fail result data predicted as normal, thereby improving performance of predicting a complete product subsequently produced.

According to various example embodiments, when data is predicted as a failure but is determined as being normal as a result of testing a complete product, a sampling rate (or sampling number) of complete products tested to determine failure and normal may be adjusted, thereby saving time or cost for testing a complete product.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A and FIG. 2B are block diagrams illustrating example configurations of an AI prediction system including an electronic device and a server according to various embodiments;

FIG. 3 is a flowchart illustrating an example method of operating an electronic device according to various embodiments;

FIG. 4A is a diagram illustrating a normal and failure prediction rate of an electronic device according to various embodiments;

FIG. 4B is a graph illustrating a prediction success rate according to a comparative example;

FIG. 4C is a graph illustrating a prediction success rate according to various embodiments;

FIG. 5 is a diagram illustrating data obtained by an electronic device according to various embodiments;

FIG. 6 is a flowchart illustrating an example method in which an electronic device controls an extraction ratio of pass result data according to various embodiments;

FIG. 7 is a diagram illustrating an example in which an electronic device controls an extraction ratio of pass result data according to various embodiments;

FIG. 8 is a flowchart illustrating an example method in which an electronic device updates an AI predictive model using fail result data according to various embodiments;

FIG. 9A is a diagram illustrating an example in which a failure prediction rate increases due to an external factor according to various embodiments;

FIG. 9B is a diagram illustrating an example in which an electronic device updates an AI predictive model using fail result data according to various embodiments;

FIG. 10 is a flowchart illustrating an example method in which an electronic device controls a sampling rate according to various embodiments; and

FIG. 11A and FIG. 11B are diagrams illustrating examples in which an electronic device controls a sampling rate according to various embodiments.

### DETAILED DESCRIPTION

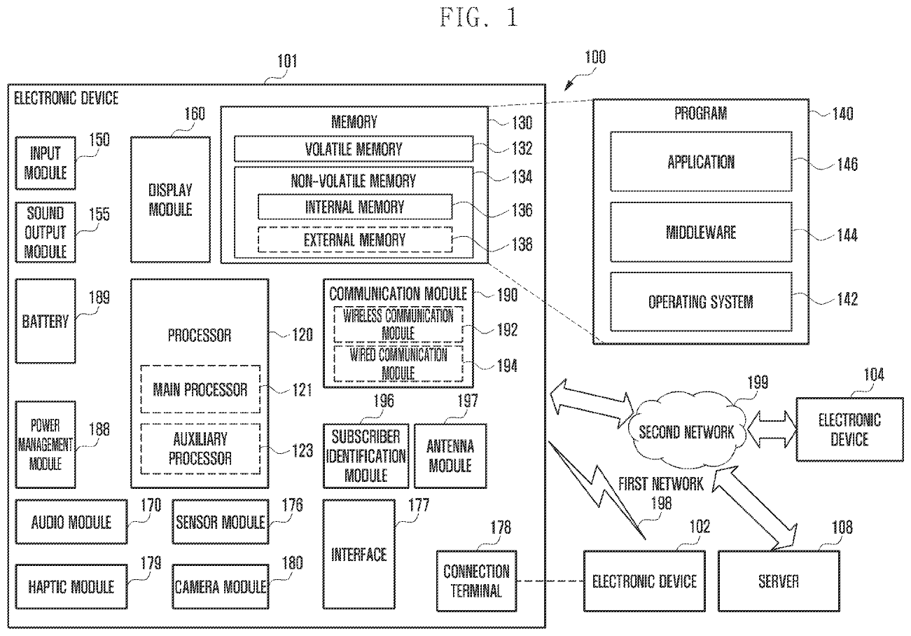

FIG. 1 is a block diagram illustrating an example electronic device 101 in a network environment 100 according to certain embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry. For example, as used herein, including the claims, the term “processor” may include various processing circuitry, including at least one processor, wherein one or more of at least one processor may be configured to perform various functions described herein. Additionally, the at least one processor may include a combination of processors performing various of the recited/disclosed functions. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used herein, the term “module” may include a unit implemented in hardware, software, or firmware, or any combination thereof, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

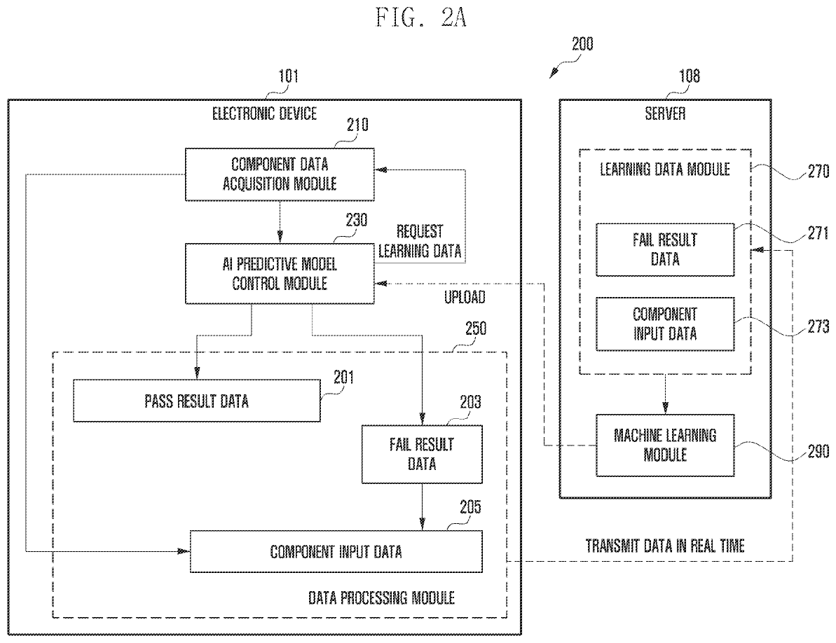

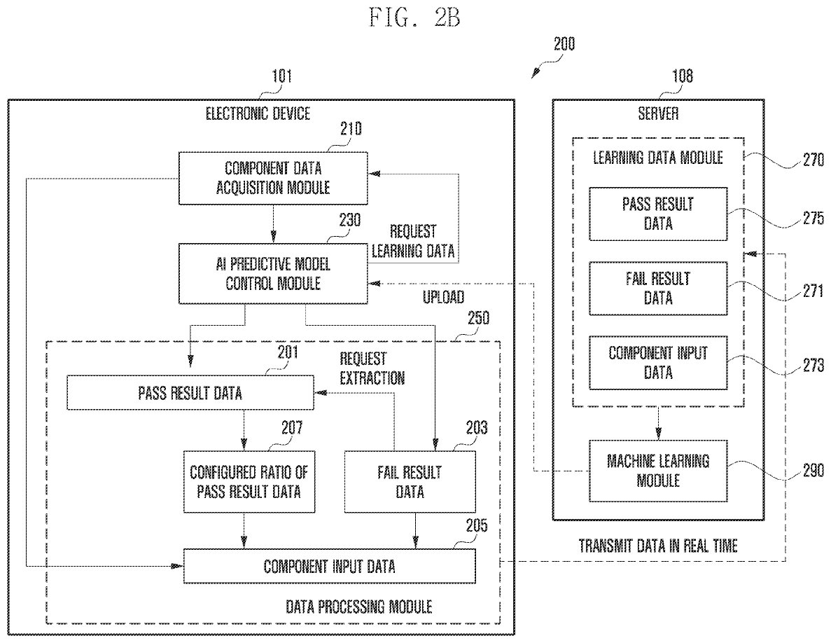

FIG. 2A and 2B are block diagrams illustrating example configurations of an AI prediction system including an electronic device and a server according to various embodiments.

FIG. 2A illustrates an example of generating an AI predictive model in an AI prediction system 200 according to various embodiments.

Referring to FIG. 2A, the artificial intelligence (AI) prediction system 200 according to various embodiments may include an electronic device (e.g., the electronic device 101 of FIG. 1) and a server (e.g., the server 108 of FIG. 1). The electronic device 101 may include at least one of a component data acquisition module 210, an AI predictive model control module 230, and a data processing module 250. Each of these modules may include various processing circuitry and/or executable program instructions. The component data acquisition module 210, the AI predictive model control module 230, and the data processing module 250 may be included in a processor (e.g., including processing circuitry) (e.g., the processor 120 of FIG. 1) of the electronic device 101. The component data acquisition module 210, the AI predictive model control module 230, and the data processing module 250 may be configured as modules operatively connected to the processor (e.g., the processor 120 of FIG. 1) of the electronic device 101. The server 108 may include a learning data module 270 and a machine learning module 290, each of which may include various processing circuitry and/or executable program instructions.

The component data acquisition module 210 may obtain component input data in real time. The component input data may include test information (e.g., a specification, performance, and a test value) about a plurality of components (or electronic components) (e.g., a processor and a camera) included in a complete product (e.g., an electronic device). The component data acquisition module 210 may provide the obtain component input data to the data processing module 250.

The AI predictive model control module 230 may generate an AI predictive model, based on the component input data. For example, the AI predictive model control module 230 may upload (or receive) the AI predictive model from the server 108 in real time. The generated (or uploaded) AI predictive model may be a first AI predictive model generated without fail result data or pass result data. The first AI predictive model may be generated based on the component input data. The AI predictive model control module 230 may predict product result data (e.g., pass result data 201 and fail result data 203) with component input data 273 (e.g., a cause) using the first AI predictive model. According to various embodiments, the first AI predictive model may be generated using an entire complete product made of a component corresponding to the component input data 273 as fail result data 271. The first AI predictive model may be generated based on the component input data 273 and the fail result data 271.

The data processing module 250 may transmit at least one of the pass result data 201, the fail result data 203, or the component input data 205 to the server 108 in real time. The data processing module 250 may obtain the component input data 205 from the component data acquisition module 210. The data processing module 250 may obtain (or receive) the pass result data 201 or the fail result data 203 from the AI predictive model control module 230. The pass result data 201 may be data determined as being normal by the AI predictive model and determined as being normal as a result of an actual test. A complete product that is determined as being normal as a result of a test may refer, for example, to the product having no abnormality (or error or malfunction) in product performance (or use) and may be normally used by a user. The pass result data 201 may be determined as being a failure by the AI predictive model but determined as being normal as a result of an actual test. The fail result data 203 may be data predicted as being faulty by the AI predictive model and determined as being faulty as a result of an actual test. A complete product that is determined as being a failure as a result of a test may refer, for example, to the product having an abnormality (or error or malfunction) in product performance (or use). The fail result data 203 may be data predicted as being normal by the AI predictive model but determined as being faulty as a result of an actual test.

The learning data module 270 of the server 108 may learn the component input data 273. The learning data module 270 may convert the component input data 273 into learning data for machine learning. The learning data module 270 may convert the component input data 273 into the learning data before the pass result data 201 and the fail result data 203 are generated. The learning data module 270 may convert fail result data 271 about all complete products made with the component input data 273 and the component input data 273 into learning data. The learning data module 270 may transmit the converted learning data to the machine learning module 290.

The machine learning module 290 may generate an AI predictive model by learning the learning data. For example, the machine learning module 290 may generate an AI predictive model by learning the component input data 273. The machine learning module 290 may generate an AI predictive model by learning the component input data 273 and the fail result data 271. The machine learning module 290 may transmit the generated AI predictive model to the electronic device 101. The generated AI predictive model may be the first AI predictive model.

FIG. 2B illustrates an example of updating the AI predictive model in the AI prediction system 200 according to various embodiments.

Referring to FIG. 2B, the component data acquisition module 210 may obtain component input data in real time. The AI predictive model control module 230 may update the AI predictive model (e.g., the first AI predictive model) generated by FIG. 2A. The AI predictive model control module 230 may update the AI predictive model, based on at least one of pass result data 201, fail result data 203, or component input data 205. According to various embodiments, the AI predictive model control module 230 may update the AI predictive model using a set ratio of pass result data 207 among the pass result data 201.

When the pass result data 201 and the fail result data 203 are obtained by the first AI predictive model, the pass result data 201 and the fail result data 203 may be transmitted to the server 108 in real time through the data processing module 250. The AI predictive model control module 230 may obtain (or receive) an updated AI predictive model from the machine learning module 290 included in the server 108. The AI predictive model obtained from the machine learning module 290 after the first AI predictive model may be a second AI predictive model. The AI predictive model control module 230 may predict product result data (e.g., the pass result data 201 and the fail result data 203) with component input data 273, pass result data 275, and fail result data 271 (e.g., cause) using the second AI predictive model. The second AI predictive model may be generated based on the fail result data 271, the component input data 273, and the pass result data 275. When the pass result data 201 and the fail result data 203 are obtained by the second AI predictive model, the pass result data 201 and the fail result data 203 may be transmitted to the server 108 in real time through the data processing module 250. The AI predictive model control module 230 may obtain an updated AI predictive model from the machine learning module 290 included in the server 108. The AI predictive model control module 230 may update the AI predictive model whenever pass result data 201, fail result data 203, or component input data 205 is obtained.

The data processing module 250 may transmit at least one of the set ratio of pass result data 207, the fail result data 203, or the component input data 205 to the server 108 in real time. The data processing module 250 may obtain the component input data 205 from the component data acquisition module 210. The data processing module 250 may obtain (or receive) the pass result data 201 or the fail result data 203 from the AI predictive model control module 230. The set ratio of pass result data 207 may refer to some pass result data extracted from the pass result data 201, based on the fail result data 203. For example, when ten pieces of fail result data 203 are detected (or extracted), ten pieces of pass result data 207 at the same or similar ratio (e.g., 1:1) may be used to update the AI predictive model.

The learning data module 270 may convert the fail result data 271, the component input data 273, and the pass result data 275 into learning data for machine learning. The fail result data 271 may correspond to the fail result data 203, the component input data 273 may correspond to the component input data 205, and the pass result data 275 may correspond to the set ratio of pass result data 207. The learning data module 270 may transmit the converted learning data to the machine learning module 290.

The machine learning module 290 may update the AI predictive model, based on the learning data. For example, the machine learning module 290 may update the AI predictive model, based on at least one of the fail result data 271, the component input data 273, and the pass result data 275. The machine learning module 290 may transmit the updated AI predictive model to the electronic device 101. The generated AI predictive model may be the second AI predictive model. The learning data module 270 may obtain data from the data processing module 250 in real time, and may convert the obtained data into learning data. The machine learning module 290 may update the AI predictive model, based on the learning data converted by the learning data module 270 to transmit the same to the electronic device 101 in real time.

According to various embodiments, the electronic device 101 and the server 108 may update the AI predictive model in conjunction with each other. The electronic device 101 and the server 108 may update the AI predictive model in real time whenever component input data, pass result data, and fail result data are obtained. When the AI predictive model is updated, pass result data and fail result data may be generated by the updated AI predictive model.

An electronic device (e.g., the electronic device 101 of FIG. 1) according to various example embodiments of the disclosure may include: a communication module comprising communication circuitry (e.g., the communication module 190 of FIG. 1), a memory (e.g., the memory 130 of FIG. 1), and at least one processor comprising processing circuitry (e.g., the processor 120 of FIG. 1) operatively connected to the communication module and/or the memory, wherein at least one processor may be configured to: generate an artificial intelligence (AI) predictive model, based on component input data, obtain fail result data according to the AI predictive model, obtain pass result data according to the fail result data, and update the AI predictive model, based on at least one of the component input data, the fail result data, and the pass result data.

At least one processor may be configured to: transmit at least one of the component input data, the fail result data, or the pass result data to a server (e.g., the server 108 of FIG. 1) through the communication module, and receive the AI predictive model from the server.

At least one processor may be configured to update the AI predictive model based on the component input data, the fail result data, or the pass result data being obtained, and obtain fail result data and pass result data predicted by the updated AI predictive model.

The fail result data may be data predicted as being normal or faulty by the AI predictive model and determined as being faulty as a result of an actual test, and the pass result data may be data determined as being normal or faulty by the AI predictive model and determined as being normal as a result of the actual test.

At least one processor may be configured to obtain the pass result data, based on a number of pieces of the fail result data.

At least one processor may be configured to: obtain the pass result data according to a set ratio based on the number of pieces of the fail result data being less than or equal to a threshold value, and change an extraction ratio (or the set ratio) of the pass result data and obtain the pass result data according to the changed extraction ratio based on the number of pieces of the fail result data exceeding the threshold value.

At least one processor may be configured to: update the AI predictive model, based on fail result data predicted as being normal by the AI predictive model and determined as a failure as a result of an actual test.

At least one processor may be configured to: obtain the pass result data according to a configured sampling rate based on there being fail result data predicted as being a failure by the AI predictive model and determined as a failure as a result of an actual test.

At least one processor may be configured to: control a sampling rate at which the fail result data and the pass result data are inspected, based on pass result data predicted as being a failure by the AI predictive model and determined as being normal as a result of an actual test.

At least one processor may be configured to: change the sampling rate based on the pass result data predicted as being the failure by the AI predictive model and determined as being normal as the result of the actual test being detected, and maintain the sampling ratio based on the pass result data predicted as being the failure by the AI predictive model and determined as being normal as the result of the actual test not being detected.

An AI prediction system (e.g., the AI prediction system 200 of FIG. 2A and FIG. 2B) according to various example embodiments of the disclosure may include an electronic device comprising circuitry (e.g., the electronic device 101 of FIG. 1) configured to: obtain fail result data according to an AI predictive model, obtain pass result data according to the fail result data, and transmit at least one of component input data, the fail result data, or the pass result data to a server, wherein the server (e.g., the server 108 of FIG. 1) is configured to: generate or update the AI predictive model, based on at least one of the component input data, the fail result data, or the pass result data, and transmit the AI predictive model to the electronic device.

The server may be configured to: update the AI predictive model whenever the component input data, the fail result data, or the pass result data is obtained from the electronic device, and transmit the AI predictive model to the electronic device, and the electronic device may be configured to obtain fail result data and pass result data predicted by the AI predictive model received from the server.

The electronic device may be configured to: obtain the pass result data according to a set ratio based on the number of pieces of the fail result data being less than or equal to a threshold value, and change an extraction ratio (or the set ratio) of the pass result data and obtain the pass result data according to the changed extraction ratio based on the number of pieces of the fail result data exceeding the threshold value.

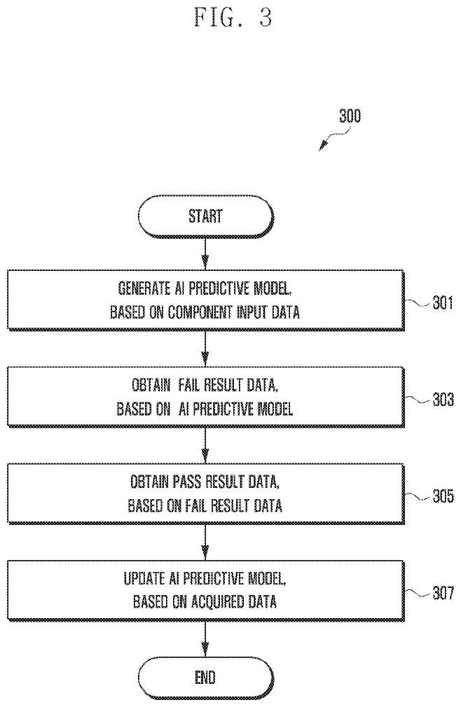

FIG. 3 is a flowchart 300 illustrating an example method of operating an electronic device according to various embodiments.

Referring to FIG. 3, in operation 301, at least one processor (e.g., the processor 120 of FIG. 1) of the electronic device (e.g., the electronic device 101 of FIG. 1) according to various embodiments may generate an AI predictive model, based on component input data. The generated AI predictive model may be a first AI predictive model generated without fail result data or pass result data. At least one processor 120 may obtain component input data in real time. The component input data may include test information (e.g., a specification, performance, and a test value) about a plurality of components (or electronic components) (e.g., a processor and a camera) included in a complete product (e.g., an electronic device). According to various embodiments, the first AI predictive model may be generated using an entire complete product made with the component input data as fail result data. For example, the first AI predictive model may be generated based on the component input data and the fail result data. At least one processor 120 may receive (or upload) the AI predictive model from a server (e.g., the server 108 of FIG. 1) through a communication module (e.g., the communication module 190 of FIG. 1).

In operation 303, at least one processor 120 may obtain fail result data, based on the generated AI predictive model. Pass result data and fail result data may be generated by the generated AI predictive model. The fail result data may be data predicted as being faulty by the generated AI predictive model and determined as being faulty as a result of an actual test. A complete product that is determined as being a failure as a result of a test may refer, for example, to the product having an abnormality (or error or malfunction) in product performance (or use). Alternatively, the fail result data may be data predicted as being normal by the AI predictive model but determined as being faulty as a result of an actual test.

In operation 305, at least one processor 120 may obtain pass result data, based on the fail result data. The pass result data may be data determined as being normal by the AI predictive model and determined as being normal as a result of an actual test. A complete product that is determined as being normal as a result of a test may refer, for example, to the product having no abnormality (or error or malfunction) in product performance (or use) and may be normally used by a user. The pass result data may be determined as being a failure by the AI predictive model but determined as being normal as a result of an actual test. At least one processor 120 may obtain pass result data, based on the number of pieces of fail result data. For example, when the number of pieces of fail result data is 10, the processor 120 may obtain ten pieces of pass result data at the same or similar ratio (e.g., 1:1).

According to various embodiments, at least one processor 120 may obtain pass result data, based on whether the number of pieces of fail result data is less than or equal to a threshold value. When the number of pieces of fail result data is less than or equal to the threshold value, at least one processor 120 may obtain pass result data according to a set ratio (e.g., 1:1). The number of pieces of fail result data being less than or equal to the threshold value may refer, for example, to fail result data having occurred the same as or similar to that predicted by the AI predictive model. When the number of pieces of fail result data exceeds the threshold value, the processor 120 may change (or adjust) an extraction ratio (or the set ratio) of pass result data. The number of pieces of fail result data exceeding the threshold value may refer, for example, to a greater number of pieces of fail result data having occurred than predicted by the AI predictive model. When the number of pieces of fail result data exceeds the threshold value, the processor 120 may increase the extraction ratio of pass result data. At least one processor 120 may obtain pass result data according to the changed extraction ratio (e.g., 1:1.5).

In operation 307, at least one processor 120 may update the AI predictive model, based on the obtained data. The obtained data may include at least one of component input data, fail result data, or pass result data. At least one processor 120 may update the AI predictive model, based on at least one of the component input data, the fail result data, or the pass result data. At least one processor 120 may receive an updated AI predictive model from the server 108 through the communication module 190.

According to various embodiments, at least one processor 120 may obtain component input data in real time, may obtain fail result data or pass result data, based on an updated AI predictive model, and may update the AI predictive model, based on at least one of the component input data, the fail result data, or the pass result data. At least one processor 120 may update the AI predictive model in real time by repeatedly performing operation 303 to operation 307.

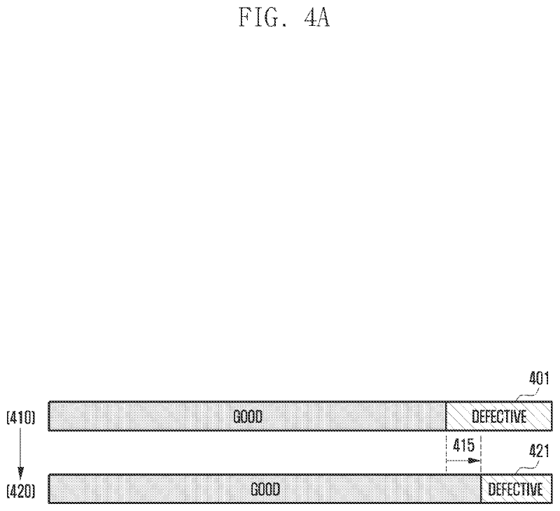

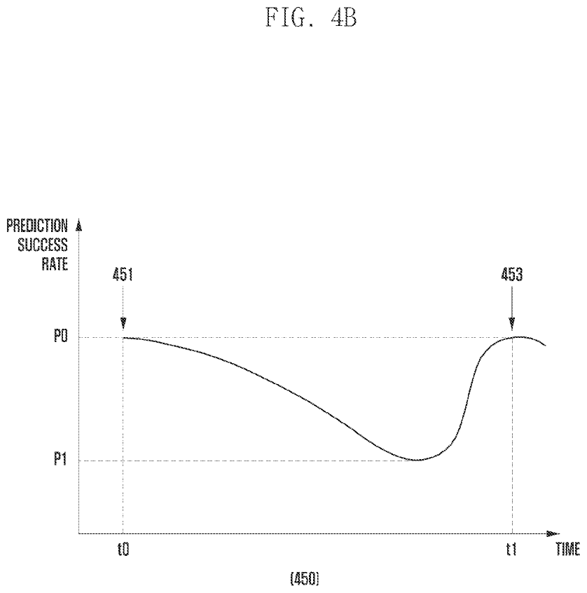

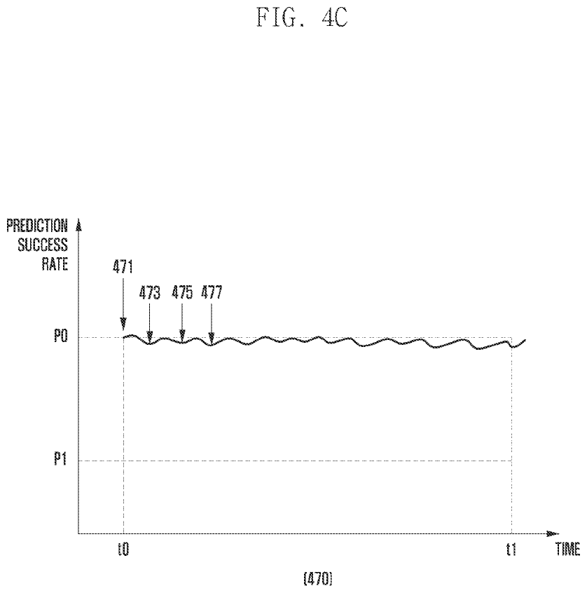

FIG. 4A is a diagram illustrating a normal and failure prediction rate of an electronic device according to various embodiments.

Referring to FIG. 4A, according to various embodiments, a defect rate 415 may be reduced in the disclosure 420 in which an AI predictive model is updated in real time compared to predicting fail result data and pass result data using a first AI predictive model 410. For example, a defect rate 401 by the first AI predictive model 410 may be greater than a defect rate 421 by the disclosure 420. When complete products are made with the same component input data, the defect rate 401 may not be reduced by the first AI predictive model 410, while the disclosure 420 may update the AI predictive model in real time, thus reducing the defect rate 415. An AI predictive model may be regarded as having good prediction performance when a defect rate is reduced.

FIG. 4B is a graph illustrating a prediction success rate according to a comparative example.

Referring to FIG. 4B, the graph 450 according to the comparative example shows that the prediction success rate decreases over time. For example, a prediction success rate 451 of a predictive model at a time t0 may decrease over time. Conventionally, once a predictive model is produced, the same prediction result may always be obtained as a result of testing the same component. Even though results of testing components are the same, results of testing complete products may be different due to a change in external factors (e.g., development of s/w technology and strengthening of a specification). To reflect a change in external factors in a prediction result, a new predictive model needs to be produced each time, and a person directly tracks a change in external factors to determine when to produce a predictive model. For example, conventionally, when a prediction success rate is a success threshold value (P1), the predictive model may be regenerated at a time t1. When the predictive model is regenerated, a prediction success rate 453 may be increased. To regenerate the predictive model, it may be necessary to test and relearn all complete products for a period.

FIG. 4C is a graph illustrating a prediction success rate according to various embodiments.

Referring to FIG. 4C, the graph 470 according to the disclosure shows that the prediction success rate changes over time but has a regular success rate (P0). For example, a prediction success rate 471 of a first AI predictive model at a time t0 may be close to P0. In the disclosure, the first AI predictive model may be updated (473) based on component input data, and fail result data and pass result data obtained by the first AI predictive model. The first AI predictive model may be updated (473) to a second AI predictive model. In the disclosure, the second predictive model may be updated (475) based on component input data, and fail result data and pass result data obtained by the second predictive model. The second AI predictive model may be updated (475) to a third AI predictive model. In the disclosure, the third predictive model may be updated (477) based on component input data, and fail result data and pass result data obtained by the third predictive model. The third AI predictive model may be updated (477) to a fourth AI predictive model. In the disclosure, an AI predictive model may be updated in real time, thereby maintaining a prediction success rate at a regular success rate (P0) over time.

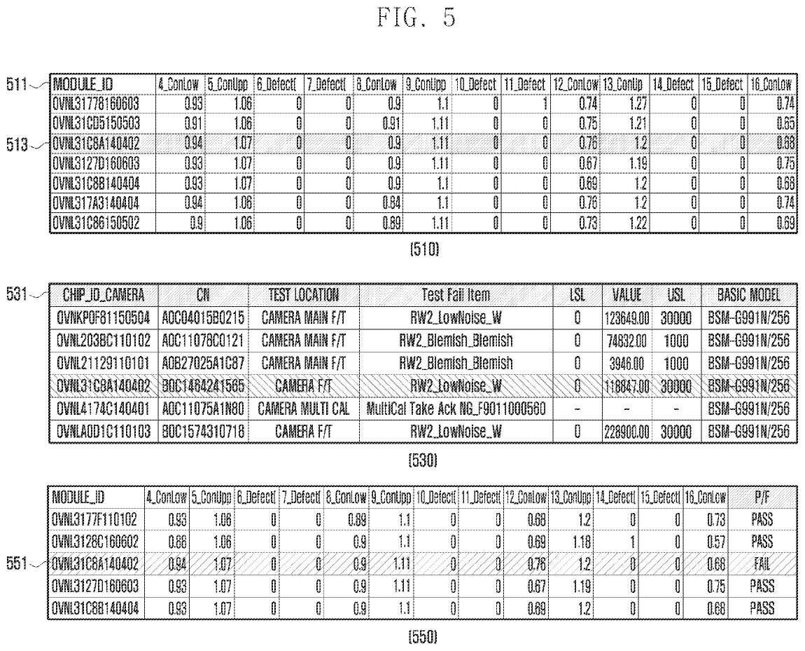

FIG. 5 is a diagram illustrating data obtained by an electronic device according to various embodiments.

Referring to FIG. 5, the electronic device (e.g., the electronic device 101 of FIG. 1) according to various embodiments may obtain a first table 510, a second table 530, and a third table 550. The first table 510 may be component input data obtained in real time. The component input data may include test information (e.g., a specification, performance, and a test value) about a plurality of components (or electronic components) (e.g., a processor and a camera) included in a complete product (e.g., an electronic device). In the first table 510, a module ID 511 may be an identifier assigned to each component. For example, the electronic device 101 may obtain component input data with a module ID 511 of OVNL31C8A140402 (513).

The second table 530 may include result data about a complete product including various components. The second table 530 may include result data about a complete product corresponding to camera chip information 531 (Chip_ID_Camera) about the complete product. The result data may include fail result data and pass result data. The electronic device 101 may match the module ID 511 of the first table 510 and the camera chip information 531 of the second table 530, thereby combining the component input data with the fail result data and the pass result data, based on the module ID 511.

The third table 550 may include fail result data and pass result data corresponding to component result data. The electronic device 101 may transmit the third table 550 to a server (e.g., the server 108 in FIG. 1). The server 108 may convert the third table 550 into learning data, and may generate and update an AI predictive model, based on the learning data. The machine learning module 290 of the server 108 may separate the third table 550 into cause learning data (e.g., component input data 551, fail result data, and pass result data) and result learning data (e.g., fail result data and pass result data) to learn the data.

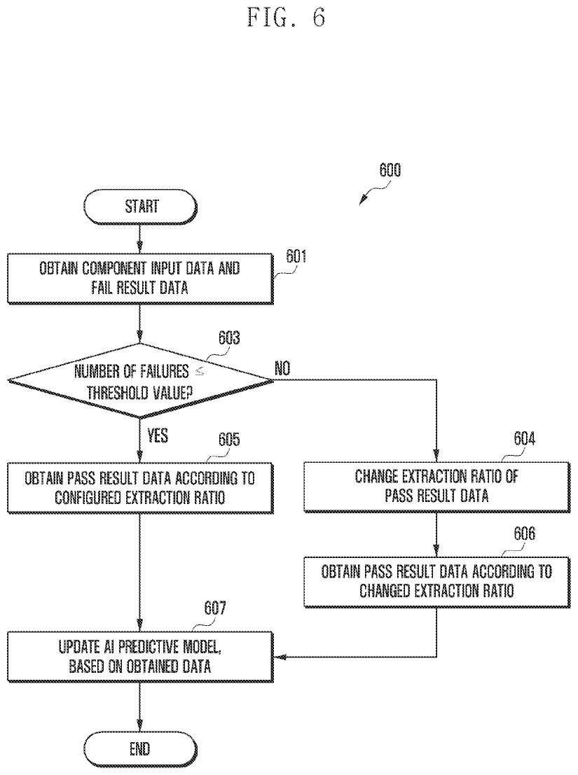

FIG. 6 is a flowchart 600 illustrating an example method in which an electronic device controls an extraction ratio of pass result data according to various embodiments.

Referring to FIG. 6, in operation 601, at least one processor (e.g., the processor 120 of FIG. 1) of the electronic device (e.g., the electronic device 101 of FIG. 1) according to various embodiments may obtain component input data and fail result data. The component input data may include test information (e.g., a specification, performance, and a test value) about a plurality of components (or electronic components) (e.g., a processor and a camera) included in a complete product (e.g., an electronic device). The fail result data may be data predicted as being faulty by an AI predictive model and determined as being faulty as a result of an actual test. A complete product that is determined as being a failure as a result of a test may refer, for example, to the product having an abnormality (or error or malfunction) in product performance (or use). Alternatively, the fail result data may be data predicted as being normal by the AI predictive model but determined as being faulty as a result of an actual test.

In operation 603, at least one processor 120 may determine whether the number of failures is less than or equal to a threshold value. The number of failures may refer to the number of pieces of fail result data. At least one processor 120 may obtain pass result data, based on whether the number of pieces of fail result data is less than or equal to the threshold value. At least one processor 120 may perform operation 605 when the number of failures is less than or equal to the threshold value, and may perform operation 604 when the number of failures exceeds the threshold value.

When the number of failures is less than or equal to the threshold value, at least one processor 120 may obtain pass result data according to a set ratio (e.g., 1:1) in operation 605. The number of pieces of fail result data being less than or equal to the threshold value may refer, for example, to fail result data has occurred the same as or similar to that predicted by the AI predictive model. The set ratio may be determined (or configured) in consideration of a number required to update the AI predictive model.

When the number of failures exceeds the threshold value, at least one processor 120 may change an extraction ratio (or the set ratio) of pass result data in operation 604. The number of pieces of fail result data exceeding the threshold value may refer, for example, to a greater number of pieces of fail result data having occurred than predicted by the AI predictive model. A greater number of pieces of fail result data than predicted by the AI predictive model occurring may refer, for example, to prediction performance being poor. At least one processor 120 may increase the number (quantity) of pieces of data for training the AI predictive model to improve the performance of the AI predictive model. When the number of pieces of fail result data exceeds the threshold value, at least one processor 120 may increase the extraction ratio of pass result data.

In operation 606, at least one processor 120 may obtain pass result data according to the changed extraction ratio. At least one processor 120 may obtain a greater number of pieces of pass result data than the set ratio. At least one processor 120 may update the AI predictive model by training the AI predictive model with the pass result data obtained greater than the set ratio together with the component input data and the fail result data. When operation 606 is completed, at least one processor 120 may perform operation 607.

In operation 607, at least one processor 120 may update the AI predictive model, based on the obtained data. The obtained data may include at least one of component input data, fail result data, or pass result data. At least one processor 120 may update the AI predictive model, based on at least one of the component input data, the fail result data, or the pass result data. The processor 120 may receive an updated AI predictive model from a server 108 through a communication module 190.

According to various embodiments, at least one processor 120 may obtain component input data in real time, may obtain fail result data or pass result data, based on an updated AI predictive model, and may update the AI predictive model, based on at least one of the component input data, the fail result data, or the pass result data. At least one processor 120 may update the AI predictive model in real time by repeatedly performing operation 601 to operation 607.

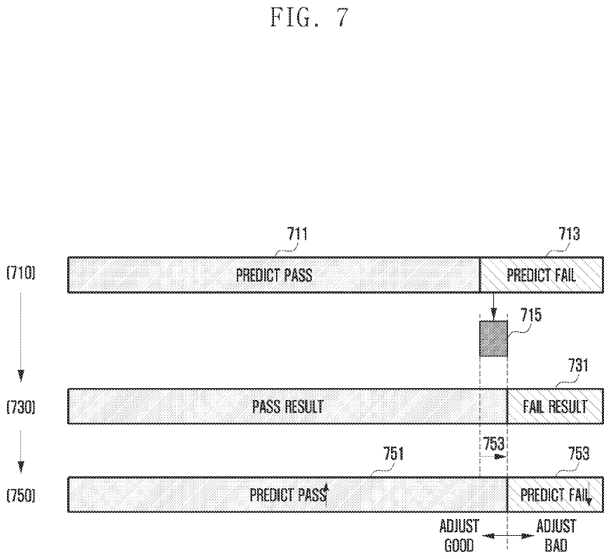

FIG. 7 is a diagram illustrating an example in which an electronic device controls an extraction ratio of pass result data according to various embodiments.

Referring to FIG. 7, the electronic device (e.g., the electronic device 101 of FIG. 1) according to various embodiments may predict pass result data 711 and fail result data 713 using an AI predictive model 710. The AI predictive model 710 may be generated based on component input data. Alternatively, the AI predictive model 710 may be generated based on component input data and fail result data about an entire complete product made of a component corresponding to the component input data.

The electronic device 101 may obtain result data 730 as a result of actually testing a complete product predicted by the AI predictive model 710. The result data 730 may include pass result data and fail result data 731. The result data may be predicted as a failure by the AI predictive model 710 but may be included in the pass result data a result of an actual test, and thus the number of pieces of fail result data 715 may be reduced. The electronic device 101 may learn the result data 730, which is predicted as a failure by the AI predictive model 710 but is normal result data as a result of the actual test, to update the AI predictive model.

The updated AI predictive model 750 may be generated based on the component input data and the result data 730. The electronic device 101 may predict pass result data 751 and fail result data 753 using the updated AI predictive model 750. As a result of prediction, the number of pieces of fail result data 753 may be reduced. When predicting normal or failure of a complete product using the updated AI predictive model 750, failure predictions may be reduced and prediction performance may be improved.

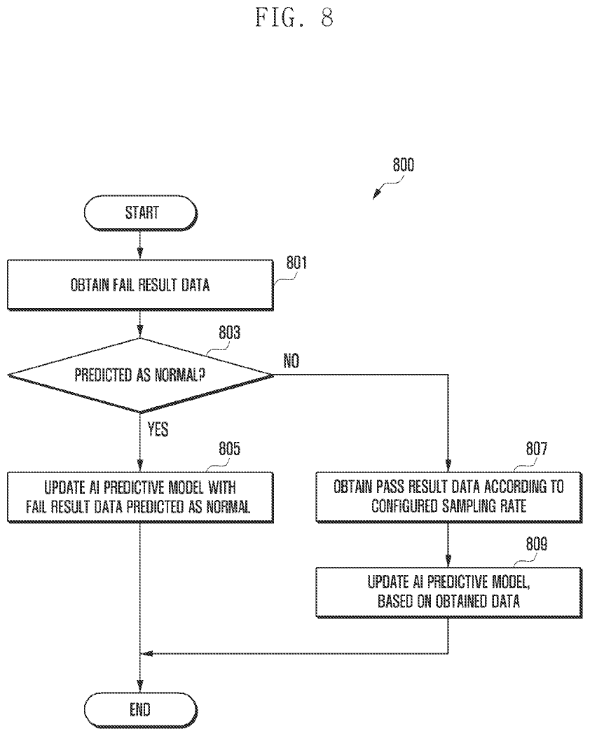

FIG. 8 is a flowchart 800 illustrating an example method in which an electronic device updates an AI predictive model using fail result data according to various embodiments.

Referring to FIG. 8, in operation 801, at least one processor (e.g., the processor 120 of FIG. 1) of the electronic device (e.g., the electronic device 101 of FIG. 1) according to various embodiments may obtain fail result data. The fail result data may be data predicted as being faulty by an AI predictive model and determined as being defective as a result of an actual test. The fail result data may be data predicted as being normal by the AI predictive model but determined as being faulty as a result of an actual test.

In operation 803, at least one processor 120 may determine whether the fail result data is predicted as being normal. The fail result data may be data predicted as being faulty or as being normal by the AI predictive model. At least one processor 120 may perform operation 805 when the fail result data is predicted as being normal, and may perform operation 807 when the fail result data is predicted as being not normal.

When the fail result data is predicted as being normal, at least one processor 120 may update the AI predictive model with the fail result data predicted as being normal in operation 805. When the fail result data is predicted as being normal by the AI predictive model but is a failure as a result of the actual test, at least one processor 120 may determine that there is a change in external conditions. When an increasing number of defects occur due to the change in external conditions (e.g., a change in specifications determined as being normal), the processor 120 may update the AI predictive model in real time. At least one processor 120 may use fail result data predicted as being faulty by an AI predictive model and pass result data predicted as being normal as learning data. The trained AI predictive model may be updated (or generated) into an AI predictive model that reflects the change in external conditions in a next prediction by reflecting the result of the test. When producing a product, repeatedly performing predict->test->learn->update the AI predictive model->predict->test->learn->update the AI predictive model may update the AI predictive model to perform more accurate prediction.

When the fail result data is predicted as not being normal (e.g., the fail result data is predicted as being faulty), at least one processor 120 may obtain pass result data according to a configured sampling rate in operation 807. The sampling rate may refer to a sampling rate (or number) at which fail result data or pass result data is actually tested. The sampling rate may be different from the extraction ratio, which represents the ratio of the number of pass result data to the number of fail result data. At least one processor 120 may configure a rate appropriate for each production facility environment by adjusting the sampling rate at which products predicted as being normal is actually tested. For example, at least one processor 120 may randomly sample and test some of pass result data predicted as being normal, and may match and learn the same with component input data to reflect the change in external conditions in the AI predictive model. When there is an increase in fail result data due to an upward adjustment of a specification, updating the AI predictive model may increase failure prediction, and may improve the accuracy of the AI predictive model. Repeating this process may make it possible to more accurately predict normal or failure.

In operation 809, at least one processor 120 may update the AI predictive model, based on the obtained data. The obtained data may include at least one of component input data, fail result data, or pass result data. At least one processor 120 may update the AI predictive model, based on at least one of the component input data, the fail result data, or the pass result data. At least one processor 120 may receive an updated AI predictive model from a server 108 through a communication module 190.

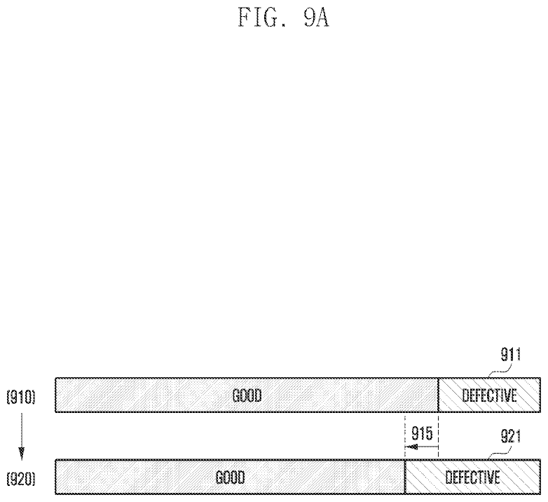

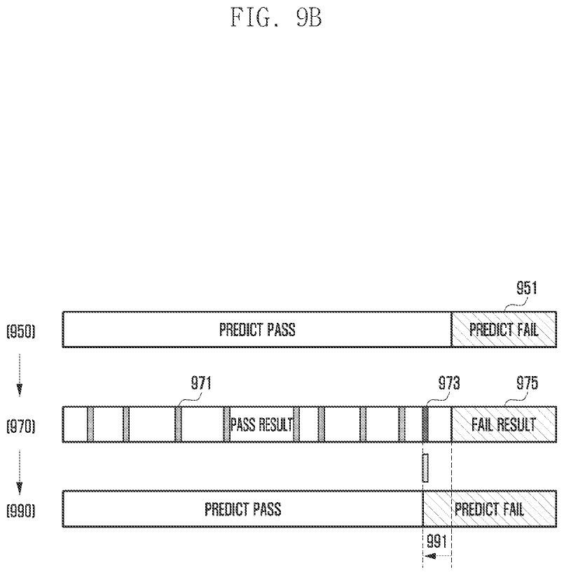

FIG. 9A is a diagram illustrating an example in which a failure prediction rate increases due to an external factor according to various embodiments.

Referring to FIG. 9A, before an external factor is changed (910), pass result data predicted as being normal and fail result data 911 predicted as being faulty may be obtained according to an AI predictive model. After the external factor is changed (920), there may be an increase in pass result data predicted as being normal by the AI predictive model may decrease and there may be a decrease in fail result data predicted as being faulty may increase (915). After the external factor is changed (920), there may be an increase in fail result data 921 obtained as a result of an actual test increases and prediction accuracy may decrease. In the disclosure, to address this problem, some of pass result data predicted as being normal may be randomly sampled, tested, and matched with component input data to be learned, thereby reflecting a change in external conditions in the AI predictive model. When there is an increase in fail result data due to an upward adjustment of a specification, updating the AI predictive model may increase failure prediction, and may improve the accuracy of the AI predictive model.

FIG. 9B is a diagram illustrating an example in which an electronic device updates an AI predictive model using fail result data according to various embodiments.

Referring to FIG. 9B, the electronic device (e.g., the electronic device 101 of FIG. 1) according to various embodiments may predict pass result data and fail result data 951 using an AI predictive model 950. The AI predictive model 950 may be generated based on at least one of component input data, pass result data, and fail result data. The electronic device 101 may obtain result data 970 as a result of actually testing a complete product predicted by the AI predictive model 950. The result data 970 may include pass result data and fail result data 975. The result data 970 may include pass result data 971 that is predicted as being normal by the AI predictive model 950 and is normal as a result of an actual test and fail result data 973 that is predicted as being normal by the AI predictive model 950 but is a failure as a result of the actual test.

The electronic device 101 may update the AI predictive model by randomly sampling the pass result data and matching and learning the pass result data 971 and the fail result data 973 with component input data. The updated AI predictive model 990 may be generated based on the component input data, the pass result data 971, and the fail result data 973. The electronic device 101 may predict pass result data and fail result data using the updated AI predictive model 990. As a result of prediction, the number of pieces of fail result data 991 may increase. When predicting normal or failure of a complete product using the updated AI predictive model 990, failure predictions may be reduced and prediction performance may be improved.

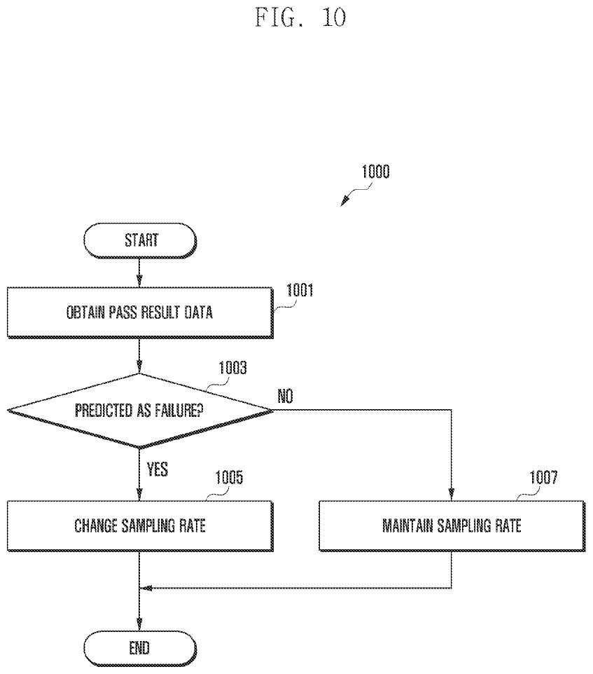

FIG. 10 is a flowchart 1000 illustrating an example method in which an electronic device controls a sampling rate according to various embodiments.

Referring to FIG. 10, in operation 1001, at least one processor (e.g., the processor 120 of FIG. 1) of the electronic device (e.g., the electronic device 101 of FIG. 1) according to various embodiments may obtain pass result data. The pass result data may be data determined as being normal by an AI predictive model and determined as being normal as a result of an actual test. A complete product that is determined as being normal as a result of a test may refer, for example, to the product having no abnormality (or error or malfunction) in product performance (or use) and may be normally used by a user. The pass result data may be determined as being a failure by the AI predictive model but determined as being normal as a result of an actual test.

In operation 1003, at least one processor 120 may determine whether there is any data predicted as a failure by the AI predictive model among the obtained pass result data. At least one processor 120 may perform operation 1005 when there is pass result data determined as being a failure by the AI predictive model but determined as being normal as a result of the actual test. At least one processor 120 may perform operation 1007 when there is no pass result data determined as being a failure by the AI predictive model but determined as being normal as a result of the actual test.

In operation 1005, at least one processor 120 may change a sampling rate. When there is pass result data determined as being a failure by the AI predictive model but determined as being normal as a result of the actual test, the processor 120 may change the sampling rate. In the disclosure, a sampling rate (or sampling number) of complete products to be tested to determine whether a complete product is faulty or normal may be adjusted, thereby saving time or cost for testing a complete product. For example, at least one processor 120 may increase or decrease the sampling rate at which fail result data and pass result data are inspected (or tested).

In operation 1007, at least one processor 120 may maintain the sampling rate. When there is no pass result data determined as being a failure by the AI predictive model but determined as being normal as a result of the actual test, the processor 120 may maintain the sampling rate. In a case of a product with no change in external factors, a predicted result is the same or similar to an actual test result, and thus the processor 120 may maintain the sampling rate at which fail result data and pass result data are inspected (or tested).

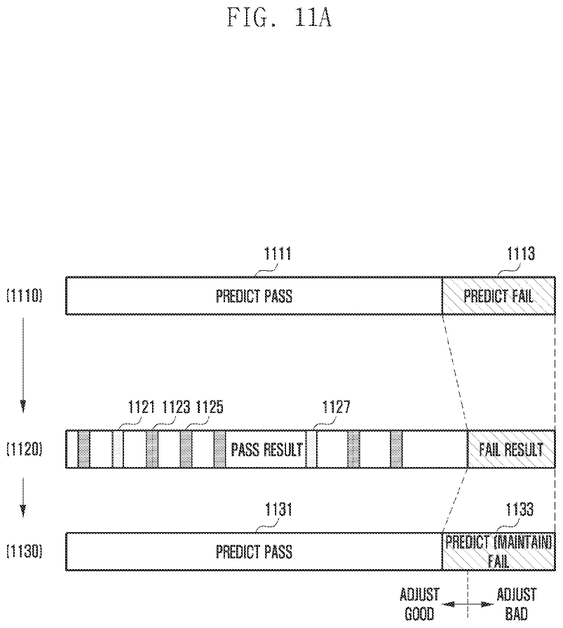

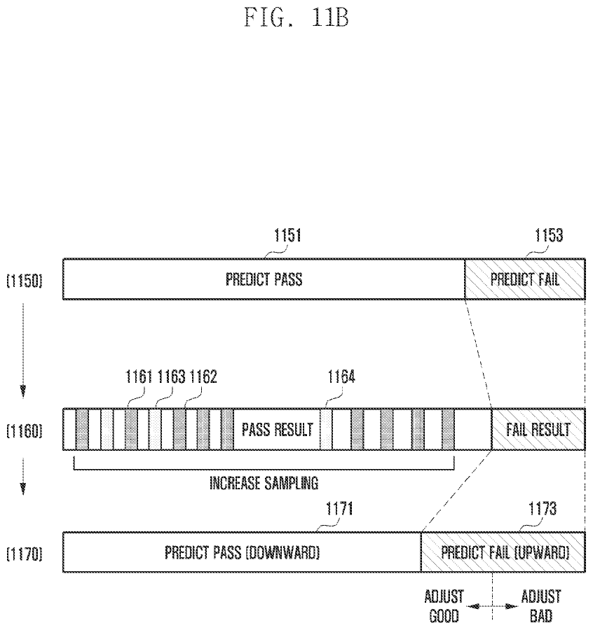

FIG. 11A and FIG. 11B are diagrams illustrating examples in which an electronic device controls a sampling rate according to various embodiments.

Referring to FIG. 11A, the electronic device (e.g., the electronic device 101 of FIG. 1) according to various embodiments may predict pass result data 1111 and fail result data 1113 using an AI predictive model 1110. The AI predictive model 1110 may be generated based on at least one of component input data, pass result data, and fail result data. The electronic device 101 may obtain result data 1120 as a result of actually testing a complete product predicted by the AI predictive model 1110. The result data 1120 may include pass result data and fail result data. The result data 1120 may include pass result data 1123 and 1125 that are predicted as being normal by the AI predictive model 1110 and are normal as a result of an actual test and fail result data 1121 and 1127 that are predicted as being normal by the AI predictive model 1110 but are failures as a result of the actual test.

The electronic device 101 may update the AI predictive model by randomly sampling the pass result data and matching and learning the pass result data 1123 and 1125 and the fail result data 1121 and 1127 with component input data. The electronic device 101 may predict pass result data 1131 and fail result data 1133 using the updated AI predictive model 1130. As a result of prediction, the number of pieces of fail result data 1133 may increase. When predicting normal or failure of a complete product using the updated AI predictive model 1130, failure predictions may be reduced and prediction performance may be improved.

Referring to FIG. 11B, the electronic device 101 may predict pass result data 1151 and fail result data 1153 using an AI predictive model 1150. The electronic device 101 may obtain result data 1160 as a result of actually testing a complete product predicted by the AI predictive model 1150. The result data 1160 may include pass result data and fail result data. The result data 1160 may include pass result data 1161 and 1162 that are predicted as being normal by the AI predictive model 1150 and are normal as a result of an actual test and fail result data 1163 and 1164 that are predicted as being normal by the AI predictive model 1150 but are failures as a result of the actual test.

When there is fail result data determined as being normal by the AI predictive model 1150 but determined as being a failure as a result of the actual test among the result data 1160, the electronic device 101 may increase a sampling rate. Alternatively, when an external change factor occurs, the electronic device 101 may increase the sampling rate. The electronic device 101 may update the AI predictive model by randomly sampling the pass result data and matching and learning the pass result data 1161 and 1162 and the fail result data 1163 and 1164 with component input data. The electronic device 101 may predict pass result data 1171 and fail result data 1173 using the updated AI predictive model 1170. As a result of prediction, the number of pieces of fail result data 1173 may increase.

A method of operating an electronic device (e.g., the electronic device 101 of FIG. 1) according to various example embodiments of the disclosure may include: generating an artificial intelligence (AI) predictive model, based on component input data, obtaining fail result data according to the AI predictive model, obtaining pass result data according to the fail result data, and updating the AI predictive model, based on at least one of the component input data, the fail result data, and the pass result data.

The method may further include: transmitting at least one of the component input data, the fail result data, or the pass result data to a server through the communication module, and receiving the AI predictive model from the server.

The obtaining of the pass result data may include: obtaining the pass result data according to a set ratio based on a number of pieces of the fail result data being less than or equal to a threshold value, and changing an extraction ratio of the pass result data and obtaining the pass result data according to the changed extraction ratio based on the number of pieces of the fail result data exceeding the threshold value.

The updating may include: updating the AI predictive model, based on fail result data predicted as being normal by the AI predictive model and determined as a failure as a result of an actual test.

The obtaining of the pass result data may include: obtaining the pass result data according to a configured sampling rate based on there being fail result data predicted as being a failure by the AI predictive model and determined as a failure as a result of an actual test.

The method may further include: controlling a sampling rate at which the fail result data and the pass result data are inspected, based on pass result data predicted as being a failure by the AI predictive model and determined as being normal as a result of an actual test.

The controlling may include: changing the sampling rate based on the pass result data predicted as being the failure by the AI predictive model and determined as being normal as the result of the actual test being detected, and maintaining the sampling ratio based on the pass result data predicted as being the failure by the AI predictive model and determined as being normal as the result of the actual test not being detected.

Various example embodiments of the disclosure and drawings are only intended to provide various examples for easily describing the technical content of the disclosure and for assisting understanding of the disclosure, and are not intended to limit the scope of the disclosure. Therefore, it should be understood that the scope of the disclosure includes all changes or modifications derived based on the technical idea of the disclosure in addition to the various example embodiments disclosed herein including the appended claims and their equivalents. It will also be understood that any of the embodiment(s) described herein may be used in conjunction with any other embodiment(s) described herein.

What is claimed is:

1. An electronic device comprising:
a communication module comprising communication circuitry;
a memory; and
at least one processor comprising processing circuitry operatively connected to the communication module or the memory,
wherein at least one processor is configured to:
generate an artificial intelligence (AI) predictive model, based on component input data;
obtain fail result data according to the AI predictive model;
obtain pass result data according to the fail result data; and
update the AI predictive model, based on at least one of the component input data, the fail result data, and the pass result data.

2. The electronic device of claim 1, wherein at least one processor is configured to:
transmit at least one of the component input data, the fail result data, or the pass result data to a server through the communication module; and
receive the AI predictive model from the server.

3. The electronic device of claim 1, wherein at least one processor is configured to:
update the AI predictive model based on the component input data, the fail result data, or the pass result data being obtained; and
obtain fail result data and pass result data predicted by the updated AI predictive model.

4. The electronic device of claim 1, wherein the fail result data includes data predicted as being normal or faulty by the AI predictive model and determined as being faulty as a result of an actual test, and
wherein the pass result data is data determined as being normal or faulty by the AI predictive model and determined as being normal based on the actual test.

5. The electronic device of claim 1, wherein at least one processor is configured to obtain the pass result data, based on a number of pieces of the fail result data.

6. The electronic device of claim 5, wherein at least one processor is configured to:
obtain the pass result data according to a set ratio based on the number of pieces of the fail result data being less than or equal to a threshold value; and
change an extraction ratio of the pass result data and obtain the pass result data according to the changed extraction ratio based on the number of pieces of the fail result data exceeding the threshold value.

7. The electronic device of claim 1, wherein at least one processor is configured to update the AI predictive model, based on fail result data predicted as being normal by the AI predictive model and determined as a failure as a result of an actual test.

8. The electronic device of claim 1, wherein at least one processor is configured to obtain the pass result data according to a configured sampling rate based on fail result data predicted as being a failure by the AI predictive model and determined as a failure as a result of an actual test.

9. The electronic device of claim 1, wherein at least one processor is configured to control a sampling rate at which the fail result data and the pass result data are inspected, based on pass result data predicted as being a failure by the AI predictive model and determined as being normal as a result of an actual test.

10. The electronic device of claim 9, wherein at least one processor is configured to:
change the sampling rate based on the pass result data predicted as being the failure by the AI predictive model and determined as being normal as the result of the actual test being detected; and
maintain the sampling ratio based on the pass result data predicted as being the failure by the AI predictive model and determined as being normal as the result of the actual test not being detected.

11. An AI prediction system comprising:
an electronic device comprising circuitry configured to: obtain fail result data according to an AI predictive model, obtain pass result data according to the fail result data, and transmit at least one of component input data, the fail result data, or the pass result data to a server, and
the server is configured to: generate or update the AI predictive model, based on at least one of the component input data, the fail result data, or the pass result data, and transmit the AI predictive model to the electronic device.

12. The AI prediction system of claim 11, wherein the server is configured to: update the AI predictive model whenever the component input data, the fail result data, or the pass result data is obtained from the electronic device, and transmit the AI predictive model to the electronic device, and
wherein the electronic device configured to obtain fail result data and pass result data predicted by the AI predictive model received from the server.

13. The AI prediction system of claim 11, wherein the electronic device is configured to:
obtain the pass result data according to a set ratio based on the number of pieces of the fail result data being less than or equal to a threshold value, and
change an extraction ratio of the pass result data and obtain the pass result data according to the changed extraction ratio based on the number of pieces of the fail result data exceeding the threshold value.

14. A method of operating an electronic device, the method comprising:
generating an artificial intelligence (AI) predictive model, based on component input data;
obtaining fail result data according to the AI predictive model;
obtaining pass result data according to the fail result data; and
updating the AI predictive model, based on at least one of the component input data, the fail result data, and the pass result data.

15. The method of claim 14, further comprising:
transmitting at least one of the component input data, the fail result data, or the pass result data to a server through a communication module; and
receiving the AI predictive model from the server.

16. The method of claim 14, wherein the obtaining of the pass result data comprises:
obtaining the pass result data according to a set ratio based on a number of pieces of the fail result data being less than or equal to a threshold value; and
changing an extraction ratio of the pass result data and obtaining the pass result data according to the changed extraction ratio based on the number of pieces of the fail result data exceeding the threshold value.

17. The method of claim 14, wherein the updating comprises updating the AI predictive model, based on fail result data predicted as being normal by the AI predictive model and determined as a failure based on an actual test.

18. The method of claim 14, wherein the obtaining of the pass result data comprises obtaining the pass result data according to a configured sampling rate based on fail result data predicted as being a failure by the AI predictive model and determined as a failure as a result of an actual test.

19. The method of claim 14, further comprising: controlling a sampling rate at which the fail result data and the pass result data are inspected, based on pass result data predicted as being a failure by the AI predictive model and determined as being normal as a result of an actual test.

20. The method of claim 14, wherein the controlling comprises:
changing the sampling rate based on the pass result data predicted as being the failure by the AI predictive model and determined as being normal as the result of the actual test being detected, and
maintaining the sampling ratio based on the pass result data predicted as being the failure by the AI predictive model and determined as being normal as the result of the actual test not being detected.
